(19) United States
(12) Patent Application Publication
(10) Pub. No.: US 2017/0024535 A1
(43) Pub. Date: Jan. 26, 2017

(54) COMMUNICATIONS SYSTEM HAVING A PLURALITY OF SENSORS TO REMOTELY MONITOR A LIVING ENVIRONMENT

(71) Applicant: Opterna Technology Limited, Limerick (IE)

(72) Inventors: Bret A. MATZ, Leesburg, VA (US); Robert E. SMITH, McLean, VA (US); William HELVIG, Emmaus, PA (US)

(21) Appl. No.: 15/215,267

(22) Filed: Jul. 20, 2016

Related U.S. Application Data
(60) Provisional application No. 62/326,252, filed on Apr. 22, 2016.
(60) Provisional application No. 62/194,650, filed on Jul. 20, 2015.

(51) Int. Cl. G06F 19/00; H04L 29/08

(52) U.S. Cl. CPC G06F 19/3418; H04L 67/12; H04L 67/306; H04L 67/22

(57) ABSTRACT

Systems to monitor and methods for monitoring the wellness and security of residents in a living community, wherein the living community has a plurality of living units each having a controller and associated sensors. Each controller is configured to receive sensor data from the associated sensors, receive input data from an access device, and send this sensor data and input data to a management platform. The management platform is configured to arrange this data, extrapolate conclusions based on this data, monitor residents in the living community, track progress of residents in the living community, and establish periodic goals for the residents in the living community.

### CROSS-REFERENCE TO RELATED APPLICATIONS

This application is based on and claims priority to U.S. Application Ser. No. 62/194,650, filed on Jul. 20, 2015, and U.S. Application Ser. No. 62/326,252, filed Apr. 22, 2016, which are incorporated herein by reference in the entirety.

### FIELD

This application relates to a communications system having a plurality of sensors to remotely monitor the wellness and security of people living in a community.

### BACKGROUND

There are a variety of sensors that are each useful for specific applications. Some sensors are used for personal health and fitness, such as monitoring the number of steps a person takes throughout a day, measuring a person's weight, or measuring a person's glucose level. Other sensors are used for home safety and monitoring, such as sensors that can detect movement within a living space, whether doors have been opened, levels of carbon monoxide, whether a gas line or water line has a leak, etc.

The sheer number of sensors is creating a movement toward the Internet-of-Things (“IoT”). The IoT is the connection of devices, wearables, vehicles, buildings, appliances, and other devices to a network commonly the Internet.

### BRIEF DESCRIPTION OF THE FIGURES

The accompanying figures show exemplary embodiments in accordance with one or more aspects of the invention.

FIG. 1 is a block diagram illustrating a system having a controller and multiple sensors, in accordance with one embodiment.

FIG. 2 is a block diagram illustrating a controller that can interface with a plurality of sensors, in accordance with one embodiment.

FIG. 3 is a block diagram illustrating a system where an access device can monitor a living environment, in accordance with one embodiment.

FIG. 4 is a block diagram illustrating a system where a management device can monitor a plurality of living units, in accordance with one embodiment.

### DETAILED DESCRIPTION

The move toward the IoT is making the world more connected than it has ever been. However, connecting various sensors to a network often requires a smartphone and a process specific to each sensor or product. So a person adding a sensor to a network will at times need a smartphone and at times need to complete numerous steps, many that require a relatively high level of familiarity with Internet technology. As a result, certain segments of the population, including the elderly, have become frustrated and in some cases are unwilling to adopt new technologies. This frustration, hesitancy, and unwillingness to use new technology has unfortunately excluded these populations from many of the benefits that the IoT can offer.

The systems and methods disclosed in this application enable the IoT to reach new populations, while improving wellness and safety. As one example, the systems and methods disclosed in the application can be applied to elderly populations residing in individual living units within a living community (e.g., senior living, retirement community, assisted living, etc.). As will be explained in more detail below, the systems and methods enable a plurality of sensors to collect data, send this data to a common network via a control unit, arrange this data either by a profile-by-profile or aggregate basis, and selectively display this data on an access device.

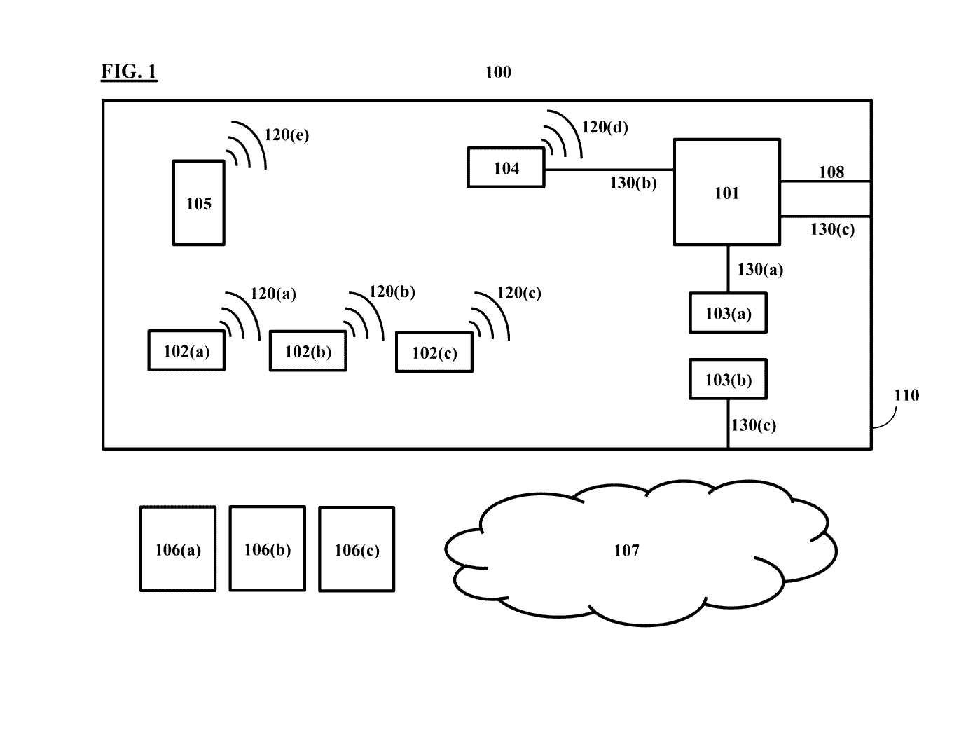

Referring to the embodiment shown in FIG. 1, system 100 includes a living environment 110. At least one person lives in the living environment 110, and the living environment 110 can be an individual home, a dormitory room, or a residence in a living community.

The living environment 110 includes a controller 101 connected to a broadband network via broadband connection 108, a plurality of wireless sensors 102(a)-(c) that can send data to the controller 101 via wireless connections 120(a)-(c), a wired sensor 103(a) that can send data to the controller 101 via wired connection 130(a), a wired sensor 103(b) that can send data to the controller 101 via wired connection 130(c), and a dual sensor 104 that can send data to the controller 101 via wireless connection 120(d) or wired connection 130(b).

The sensors 102(a)-(c), 103(a)-(b), and 104 can be temperature sensors, motion-detection sensors, contact sensors, accelerometers, pressure sensors, air-flow sensors, liquid-flow or level sensors, glucose sensors, chemical sensors (e.g., carbon-monoxide sensor), battery-charge sensors, heart-rate sensors, blood-pressure sensors, sleep-quality sensors, push-button sensors, etc. A smartphone can also serve as or include at least one sensor. This list is not meant to be limiting. Rather, the system is workable with any sensor capable of detecting or measuring a change in a physical property mechanically or electronically.

The sensors 102(a)-(c), 103(a)-(b), and 104 can be located in or themselves be wearable devices, stationary devices, or appliances. For example, the sensors 102(a)-(c), 103(a)-(b), and 104 could be in a wearable pendant, a wristband, or a clip-on device. The sensors 102(a)-(c), 103(a)-(b), and 104 could be located on a door frame or window frame to sense whether the door or window is open. The sensors 102(a)-(c), 103(a)-(b), and 104 could be in large appliances such as a washing machine, stove, refrigerator, fan, air conditioner, etc. And the sensors 102(a)-(c), 103(a)-(b), and 104 could be in small appliances such as a dehumidifier, iron, vacuum cleaner, etc.

The system 100 is only representative, so the number of sensors and types of connections can vary.

Sensors are easily added to the system 100. If someone wants to add a sensor to the system 100, the additional sensor is simply moved in close proximity to the controller 101. Alternatively, sensors can be pre-paired with the controller 101, allowing the person residing in the living environment 110 to add a new sensor to the system 100 without performing a formal set-up procedure. In one embodiment, a system administrator or someone having access to a management platform can remotely register a new sensor or a new device. In doing so, the sensor can be paired to the right controller before the sensor or device is sent to a resident. Additionally, issues with connectivity and pairing can be remotely resolved.

Pre-pairing and autonomous pairing can occur in part because the controller 101 can include a gateway function. This gateway function results from networking hardware in the controller 101 that enables the controller 101 to interface with, send data to, and receive data from various sensors via Bluetooth, Wi-Fi, wired, broadband, or other connections.

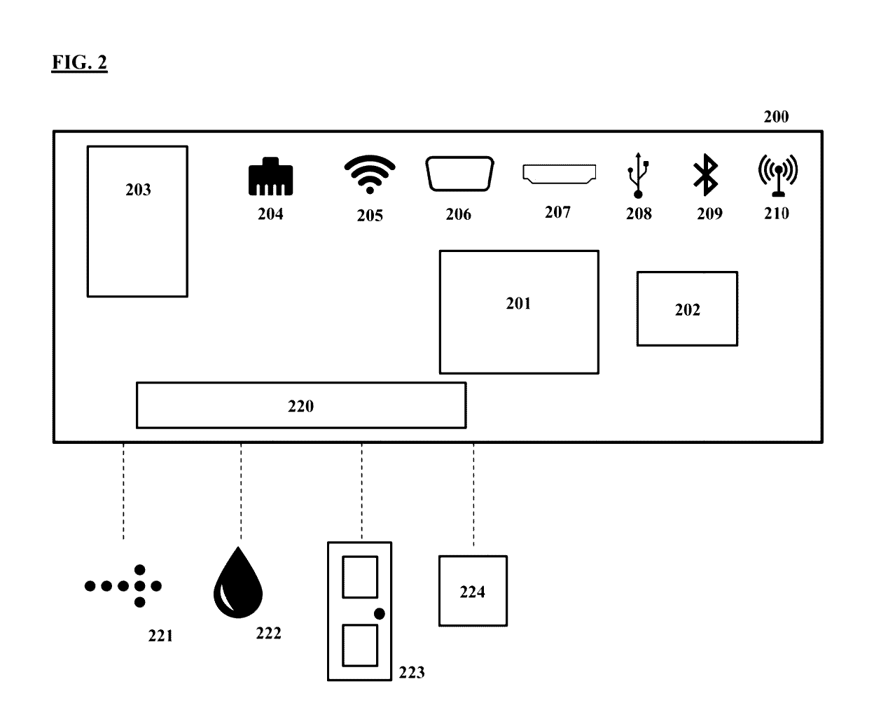

FIG. 2 depicts a controller 200 that can perform a gateway function and a routing function in accordance with one embodiment. As shown, the controller 200 includes a processor 201, memory 202, power supply 203, Ethernet connection 204, wireless access point 205, serial port 206, HDMI port 207, USB port 208, Bluetooth receiver 209, and transceiver/receiver 210. The controller 200 also shows wired connections 220, which could be in the form of terminals.

The controller 200 can interface with a plurality of sensors, as shown with dashed lines in FIG. 2 and as described with reference to FIG. 1. For example, sensors could interface using wired connections 220 or wireless connections. In FIG. 2, the sensors are a wearable-device sensor 221, water sensor 222, door sensor 223, and motion sensor 224. These sensors 221-224 can send sensor data to the controller 200 using wired connections or one of the available wireless options. Once the sensors 221-224 send data to the controller 200, the controller 200 can either save the sensor data to the memory 202, send the sensor data to an external device by using the transceiver/receiver 210, send the sensor data to a service-provider network via Ethernet connection 204, or send the sensor data to a local network, such as a living-community network.

The types and number of components in the embodiment shown in FIG. 2 is representative but should not be considered limiting. Other embodiments, for example, might not have all of the connections and interfaces shown in FIG. 2. Other embodiments could also include additional connections, which are not shown.

Referring back to FIG. 1, the living environment 110 of the system 100 can include a user device 105. The user device 105 can be a tablet, smartphone, laptop computer, desktop computer, or other device capable of displaying images or messages. The user device 105 may be mounted on a wall in the living environment 110, or the user device 105 may be a mobile device. As shown in FIG. 1, the user device 105 interfaces and communicates with the controller 101 via wireless connection 120(e). Alternatively or additionally, this interface and communication could occur over a wired connection.

Using at least one connection between the user device 105 and the controller 101, a resident of living environment 110 can input data into the user device 105. Input data can include profile information, medicine intake, food intake, blood pressure, weight, glucose level, or other measurements. The user device 105 can also enter activity goals or other milestones for the person residing in the living environment 110.

After or while the controller 101 collects input data and sensor data from the user device 105 and sensors 102(a)-(c), 103(a)-(b), 104, the controller 101 allows a management platform 107 to arrange this data. To have this data arranged, the controller 101 syncs with a management platform 107. Syncing can either occur automatically every period of time (e.g., one minute, five minutes, ten minutes, hour, etc.) or manually.

The management platform 107 can be located on an external server or internal to the controller 101. If the management platform 107 is located on an external server, the controller 101 is configured to send data to the server or a local network. One way to send data is via the broadband connection 108. Another way to send data is via a wireless connection. If the management platform 107 is internal to the controller 101, the controller may save input data and sensor data to an internal memory, which is accessible by the management platform 107.

The system 100 can include access devices 106(a)-(c). Access device 106(a) is a tablet, access device 106(b) is laptop computer, and access device 106(c) is a smartphone. But access devices 106(a)-(c) are only representative. The number of access devices and the types of access devices can vary. Ultimately, an access device 106 can be any device configured to receive sensor data from the management platform 107 and display this sensor data.

The access devices 106(a)-(c) can access sensor data, but the access devices 106(a)-(c) can only do so when granted permission or after entering a password. If the proper permission is granted or the correct password is entered, the management platform 107 allows the respective access devices 106(a)-(c) to view current and past data generated from the sensors 102(a)-(c), 103(a)-(b) or inputted from the user device 105.

The access devices 106(a)-(c) can remotely access and view data. For example, family members can remotely view input data and sensor data to monitor or confirm that a resident in the living environment 110 has been active, has been taking her or his medicine, and is safe.

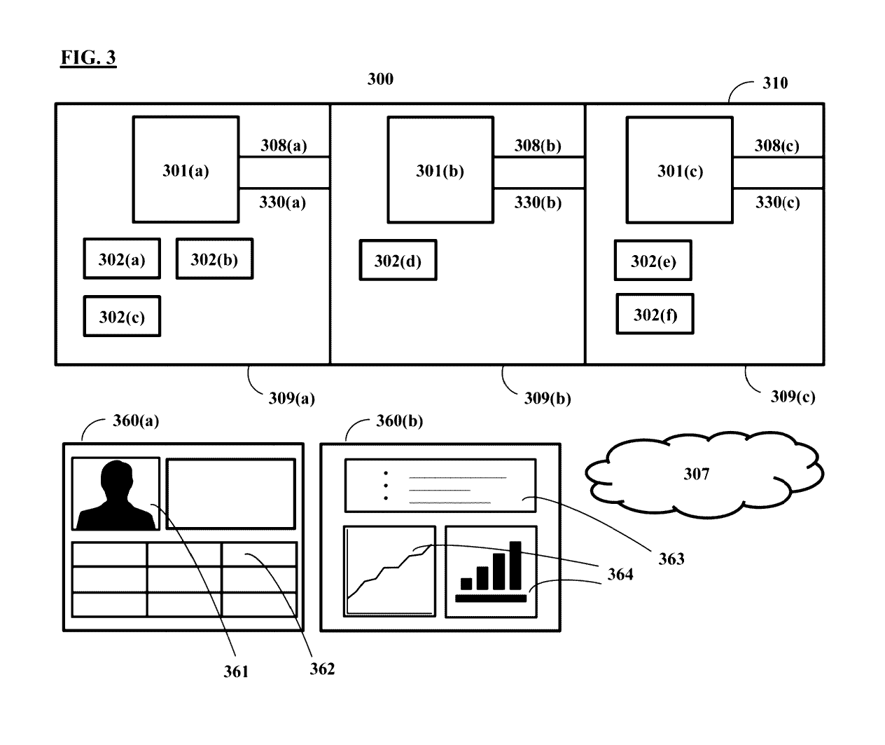

The access devices 106(a)-(c) can display data in multiple formats, such as graphs, spreadsheets, etc. A representation is shown in FIG. 3.

Referring to the embodiment shown in FIG. 3, the system 300 includes a living environment 310 having three adjacent living units 309(a)-(c). Although FIG. 3 depicts three living units 309(a)-(c), other embodiments could have many additional living units. And the living units 309(a)-(c) do not need to be adjacent to each other. Some embodiments may even have living units in separate buildings.

At least one individual resides in each living unit 309(a)-(c), and each living unit 309(a)-(c) has a separate controller 301. The controllers 301(a)-(c) in the embodiment shown in FIG. 3 are positioned in different locations in each living unit 309. However, the controllers 301(a)-(c) could be positioned in the same location of each respective living unit 309(a)-(c).

The controllers 301(a)-(c) each have a broadband connection 308 and a wired connection 330. The wired connections 330(a)-(c) can be shared between living units 309(a)-(c), for example as part of a local network, or be isolated to each corresponding living unit 309. Other embodiments may not have broadband connections 308(a)-(c) or may not have wired connections 330(a)-(c).

Each living unit 309 has at least one sensor 302. Similar to how the sensors 102(a)-(c), 103(a)-(b), and 104 in the FIG. 1 embodiment could use wireless and wired connections, the sensors 302(a)-(c) can interface and communicate with the controller 301(a)-(c) using a wireless or wired connection. Sensors 302(a)-(c) can interface and communicate with controller 301(a). Sensor 302(d) can interface and communicate with controller 301(b). And sensors 302(e) and 302(f) can interface and communicate with controller 301(c).

Sensors 302 can be living-unit specific, meaning that any given sensor 302 can only interface and communicate with one controller 301 (e.g., sensor 302(b) can only interface with controller 301(a)). Alternatively, sensors 302(a)-(f) can interface and communicate with the nearest controller 301, meaning that a sensor 302 will interface and communicate with the controller 301 assigned to the living unit 309 where the sensor 302 is positioned. For example, sensor 302(c) may be located in or be a wearable device. Or sensor 302(c) may be a smartphone emulating a wearable device. If an individual wearing or carrying sensor 302(c) leaves the living unit 309(a) and enters the living unit 309(b), the sensor 302(c) can interface and communicate with the controller 301(b).

At least one individual may reside in each of the living units 309(a)-(c). Each individual may have a dedicated wearable device. For example, an individual residing in living unit 309(a) may wear sensor 302(a), another individual residing in living unit 309(a) may wear sensor 302(b), an individual residing in living unit 309(b) may wear sensor 302(d), and an individual residing in living unit 309(c) may wear sensor 302(e).

Controllers 301(a)-(c) therefore can collect sensor data from wearable sensors from individuals residing in the living environment 310.

Similar to the controller 101 in FIG. 1, the controllers 301(a)-(c) send sensor data to be accessed by the management platform 307. The management platform 307 can interface directly or indirectly with the controllers 301(a)-(c). The management platform 307 can collect sensor data from the controllers 301(a)-(c), arrange the sensor data, store the sensor data in a database, grant selective access to the sensor data, and send the sensor data to the access devices 360(a) and 360(b) for display.

Access devices 360(a) and 360(b) can be a tablet, smartphone, laptop computer, desktop computer, or any other device configured to receive sensor data after interfacing with management platform 307. To receive and display sensor data, the access devices 360(a) and 360(b) interface with the management platform 307, either directly or indirectly.

The access devices 360(a) and 360(b) can be remote access devices or management access devices. For the former, the access devices 360(a) and 360(b) can only access sensor data associated with one profile (e.g, the profile assigned to selected sensors 302(a)-(c) in the living unit 309(a)). Further, the access devices 360(a) and 360(b) can only access this sensor data if the access devices 360(a) and 360(b) have been granted permission to access the profile or someone has entered a password to access the profile.

If the access devices 360(a) and 360(b) are management devices, the access devices 360(a) and 360(b) have greater permissions to sensor data in the living environment 310. For example, if the access devices 360(a) and 360(b) have management access, the access devices 360(a) and 360(b) might have access to sensor data from all or most of the living units 309(a)-(c) in the living environment 310.

Access devices 360(a) and 360(b) can display sensor data in many different formats. As one example, access device 360(a) can display a profile view for an individual residing in the living environment 310. The display includes a profile picture 361 and data fields 362. In some embodiments, the access device 360(a) can input data into data fields 362. For example, a manager may input profile information, medicine intake, food intake, blood pressure, weight, glucose level, or other measurements in data fields 362. This input data can be saved on the access device 360(a) or be saved elsewhere, such as on an external server. The management platform 307 may have access to this input data, arrange this input data, and send this input data to other access devices.

The access device 360(b) depicts another display of sensor data or input data. As depicted in FIG. 3, the access device 360(b) includes graphs 364 and goals 363. Graphs 364 can show progress over time or a comparison of one resident to either another resident or to an average of other residents in the living environment 310.

The goals 363 can be associated with residents from the living environment 310. So the resident from the living unit 309(a) may have personalized goals different from those for the resident from the living unit 309(b). The goals 363 can be daily, weekly, monthly, or yearly goals. The goals 363 can indicate whether a resident has recently met a goal. The goals 363 can also recommend new programs or services for the resident based on the sensor data or input data corresponding to the resident.

The goals 363 can be extrapolated from sensor data associated with residents in the living environment 310. The goals 363 can also be manually entered into an access device 360(a)-(c) or a user device. Different residents will have different associated data, needs, and aspirations, so the goals 363 can be set using personalized medicine and personal milestones.

The management platform 307 can periodically send the goals 363 to residents from the living environment 310. The management platform 307 can send the goals 363 to personal access devices if a resident has a personal access device. The management platform 307 may also send the goals 363 to the controllers 301(a)-(c) or user devices (not shown). When the goals 363 are sent to at least one of the controllers 301(a)-(c) or user devices, the controllers 301(a)-(c) or user devices may have either a display panel or an audio output to view or hear the goals 363. Accordingly, an resident from the living unit 309(a) can receive a daily or weekly goal.

Using goals 363, embodiments of the system 300 can incorporate a “buddy” system. For example, a resident from the living unit 309(a) can have a buddy residing in a separate living unit 301(b) or 301(c). With this buddy system, the goals 363 associated with the resident from the living unit 309(a) can be sent to a device or controller associated with a buddy. The buddy can then receive the goals 363 and help ensure that the resident from the living unit 309(a) meets her or his goals 363. The buddy system also can be used to send notifications, manually or automatically based on sensor data, to a buddy. A notification can be sent for encouragement, based on need, to signal distress, or signal a need for help.

The management platform 307 can arrange sensor data and input data on a profile-by-profile basis or in the aggregate. Aggregate data over a period of time (e.g., a year, five years, six months, twenty years, etc.) or trend data can be used to assess the health of an average individual residing in the living environment 310. Such information is useful to determine whether the community needs additional services or whether someone should reside or move from the living environment 310. Aggregate data or trend data can also be used in scientific studies related to age, health, body composition, activity level, etc. And Aggregate data or trend data can be used to compare an individual's sensor data to the average resident. Accordingly, selective services, coaching, or treatment can be better allocated amongst residents in the living environment 310.

The management platform 307 can also generate reports. Reports can be sent to family members of residents from the living environment 310. Reports can also be sent to physicians, trainers, or other service providers. Overall, collecting, arranging, and analyzing profile data and comparing the profile data to an aggregate sample can both track wellness over a period of time and help implement necessary changes to improve wellness of residents from the living environment 310.

The system 300 has multiple avenues to send sensor data to the management platform 307. Controllers 301(a)-(c) can send sensor data to the management platform 307 via a service-provider network. Controllers 301(a)-(c) can also send sensor data to the management platform 307 via a local network, such as a living-community network. Having multiple available avenues to send sensor data is particularly beneficial for instances where the service-provider network is unavailable (e.g., a lost connection or when individuals residing in a living unit 309 choose to not subscribe to the service-provider network). In these instances, the controllers 301(a)-(c) can connect to and send sensor data to the local network via wired or wireless connections. For example, the system 300 could have the controller 301(a) automatically connect to the local network through the wired connection 330(a) or the broadband connection 308(a) when the controller 301(a) senses that the service-provider network is unavailable. The controller 301(a) can thus send the sensor data to the management platform 307 via the local network. In instances where the connection to the service-provider network is re-established, the controllers 301(a)-(c) can manually or autonomously switch back to sending the sensor data to the management platform 307 via the service-provider network.

In instances where a controller 301 needs to switch from the service-provider network to the local network, certain embodiments may utilize a Wi-Fi interface to the local network. If the Wi-Fi interface is the same interface used to collect sensor data from wireless sensors, the controller may not be able to receive certain sensor data from wireless sensors when the controller 301 is connected to the local network. So certain embodiments may be set up to connect the controller 301 to the local network via a connection independent from the connection used to collect sensor data from wireless sensors. In this case, the controller 301 may collect sensor data from wireless sensors while being connected to the local network.

The local network is not only beneficial as a back-up network to send sensor data to the management platform 307. The local network is also beneficial to have the controllers 301(a)-(c) directly send information to each other. For example, the controller 301(a) can use a local network to deliver time-sensitive alerts to the controllers 301(b) and 301(c) or send goals associated with the buddy system. In instances of immediate emergency, sending information between controllers 301(a)-(c) allows residents from neighboring living units to quickly provide necessary assistance to a resident in trouble.

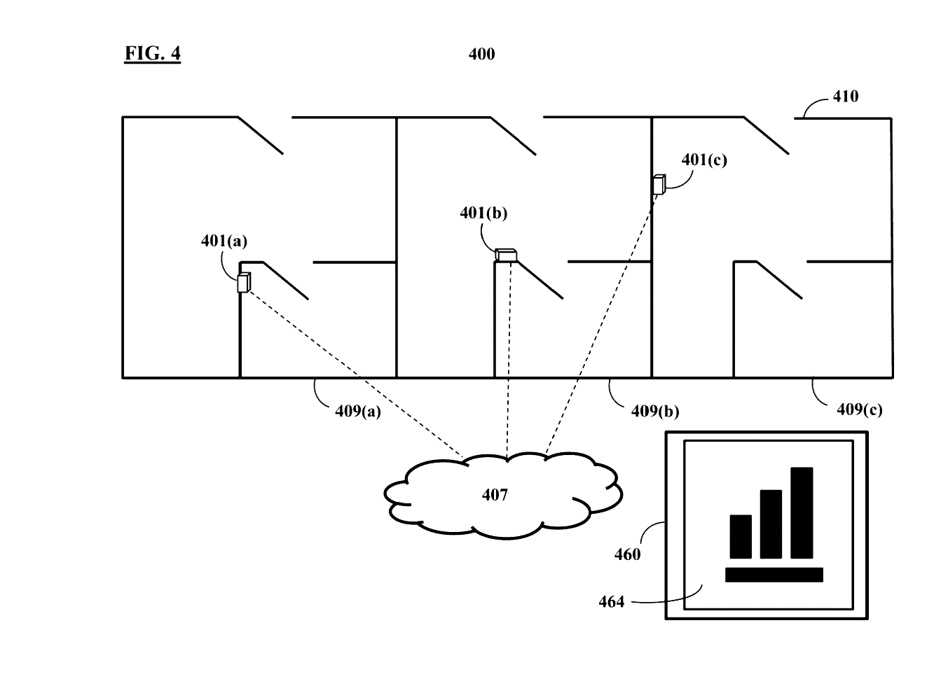

Now referring to the embodiment shown in FIG. 4, the system 400 includes living environment 410 having three living units 409(a)-(c). Although FIG. 4 depicts three living units 409(a)-(c), other embodiments could have many additional living units.

At least one individual lives in each living unit 409(a)-(c), and each living unit 409(a)-(c) has a separate controller 401, which may be located at either the same or different positions of each respective living unit 409(a)-(c).

Each controller 401(a)-(c)receives sensor data from sensors paired to each respective controller. For example, the controller 401(a) can receive sensor data from a wearable sensor, such as a sensor worn by an individual residing in the living unit 409(a). Additionally or alternatively, each controller 401(a)-(c) can be paired to a plurality or all sensors worn by residents of the living community 410. So controller 401(a) can be paired to sensors worn by individuals residing not only in living unit 409(a) but also sensors worn by individuals residing in living unit 409(b) and living unit 409(c).

Each controller 401(a)-(c) syncs to a management platform 407. From the management platform 407, the sensor data can be aggregated and arranged on a profile-by-profile basis. In the embodiment shown in FIG. 4, the management platform 407 receives sensor data from the controller 401(a), the controller 401(b), and the controller 401(c). This sensor data can respectively correlate to profile (a), profile (b), and profile (c). The sensor data can then be arranged in a manner that enables a user with a management device 460 to compare the sensor data between individuals residing in living units 409(a)-(c). As shown in FIG. 4, the management device 460 displays a graph 464, which compares the sensor data (e.g., the number of steps, minutes of activity, sleep quality, blood pressure, etc.) of three individuals residing in living units 409(a)-(c). This display can compare the sensor data from a day-by-day snapshot or over a longer period of time, even beyond several years.

With aggregate data, a manager viewing sensor data on the management device 460 can quickly and easily assess which individuals from the living environment 410 are the most active and which individuals are the least active. A manager can also assess which individuals are sleeping well and which individuals are sleeping poorly. Further, a manager can assess which individuals have health concerns and how these individuals are progressing over a period of time.

The system 400 provides management with aggregate data and profile-by-profile data. The system 400 can also be used to locate and monitor individuals residing in the living environment 410. As one example, a resident from living unit 409(c) may be needed to take medicine, have a snack, see a visitor, or in time of an emergency. To locate this resident, a manager can use the management device 460 to see which controller(s) 401 the resident's wearable device, or smartphone emulating a wearable device, last synced, last pinged, or where the resident's wearable device is currently synched. If a wearable device from living unit 409(c) had last pinged, last synched, or is currently synced with the controller 401(a), the resident from living unit 409(c) is likely in living unit 409(a).

The management platform 407 can also determine the person's location based on a plurality of the controllers. If there is a situation where the property manager or someone else needs to locate that person, then she or he can use a plurality of the controllers (possibly all of the controllers) to locate that person based on the identity of the wearable device. So the plurality of or all of controllers' gateways will be queried to identify the controllers receiving pings or currently synching with the person's wearable device. After or while performing this search, the plurality of controllers will respond to the management platform 407. All of the controllers can respond, regardless of whether the controller has received a ping from the person's wearable device. In other embodiments, only the controllers that received a signal from the person's wearable device will respond. Based on responses from the controllers, the management platform can determine the location of the person's wearable device, and hence the person's location.

The living environment 410 may be in a high-density multi-floor environment, so if the person is on the fourth floor, nearby controllers on the fourth floor may receive a ping from the person's wearable device. However, controllers on the third and fifth floor may also receive a ping. To pinpoint the actual location, it is imperative for the management platform 407 to differentiate between signal strength or some other metric to locate the person's wearable device within the living environment 410. For example, the management platform 407 may locate the person based on the strength of the signals received at the plurality of controllers; the stronger the signal, the closer the person is to that controller.

For another embodiment, each sensor is paired to only one controller. In this embodiment, a resident's respective controller can approximate the location of the resident. A resident from living unit 409(c) will have a wearable device paired to controller 401(c). The controller 401(c) can identify other sensors within range, but the controller 401(c) will receive transmissions only from the wearable device and other sensors paired to the controller 401(c). Based on the signal strength received at the controller 401(c) or data within the transmission, the controller 401(c) can approximate not only the resident's distance from the controller 401(c) but also the resident's location within the living environment 410.

For these location-search features, some embodiments may have controllers 401 save, in a memory, information received from sensors or the identity of the sensors detected over a period of time. This information, including identity information, can be saved for later use during a location-search request, for example. Therefore, when a manager sends queries out to the controllers 401 to locate a particular resident, the controllers 401 can immediately send information back to the management platform to quickly locate the resident based on the past location of the resident's wearable device.

Embodiments can also use movement information for safety. If the wearable-device sensor from living unit 409(c) has not moved over an extended period of time, management should check in on the individual residing in living unit 409(c) to see if this individual is incapacitated or if the battery in the wearable-device sensor needs to be charged or changed.

The system 400 can also monitor residents from the living environment 410 by using multiple sensors in tandem. A resident from living unit 409(a) may wear a wearable-device sensor or have a smartphone or other device capable of emulating a wearable-device sensor, and the living unit 409(a) may include a sensor that identifies movement or activity in the living unit 409(a). Collectively, sensor data from these various sensors can lead to valuable conclusions.

For example, when aggregating information from various sensors, the wearable-device sensor and a motion sensor(s) in the living unit 409(a) may sync and send data to the nearest controller 401 or only to controller 401(a). Syncing and sending data to a controller 401 can occur every interval of time (e.g., every minute, five minutes, twenty minutes, hour, etc.), but other embodiments may be random or based on the availability of a connection. The controllers 401(a)-(c) each relay sensor data to the management platform 407, and a manager or remote-access user can view this information from the management device 460.

After the sensor data is collected, the system 400 can extrapolate a conclusion based on the sensor data, as shown in the table below. The table shows ten cases. In each case, a conclusion can be drawn based on two data points: (1) the last received location of the wearable sensor and (2) the last received movement or activity in living unit 409(a).

| | Last Location of | | Last Activity in | | |
|---|---|---|---|---|---|
| Case | Wearable Sensor | | Room 409(a) | | Conclusion |
| 1 | 1 min. ago in 409(a) | | 1 | min. ago | Resident is in 409(a) |
| | | | | | and is Active |
| 2 | 1 min. ago in 409(a) | | 15 | min. ago | Resident is in 409(a) |
| | | | | | and is not Active |
| 3 | 1 min. ago in 409(a) | | 4 | hrs. ago | Resident is in 409(a) |
| | | | | | and is Resting |
| 4 | 1 min. ago in 409(a) | | 12+ | hrs. ago | Need to check Resident |
| 5 | 1 min. ago in 409(b) | | 1 | min. ago | Resident is in 409(b); |
| | | | | | Someone Else is in |
| | | | | | 409(a) |
| 6 | 1 min. ago in 409(c) | | 2+ | min. ago | Resident is in 409(c); |
| | | | | | No Activity in 409(b) |
| 7 | 5+ | min. ago | 1 | min. ago | Resident's Whereabouts |
| | | | | | Unknown; Someone in |
| | | | | | 409(a) |
| 8 | 5+ | min. ago | 5+ | min. ago | Resident's Whereabouts |
| | | | | | Unknown; No Activity |
| | | | | | in 409(a) |
| 9 | 12+ | hrs. ago | 1 | min. ago | Check Wearable Sensor |
| 10 | 12+ | hrs. ago | 12+ | hrs. ago | Resident is Away from |
| | | | | | the Living Community |
| | | | | | 410 |

As shown in the table above, when using a wearable-device sensor and activity sensors in tandem, management or the system 400 itself can determine a resident's location, whether a resident needs to be checked, whether the resident's wearable-device sensor needs to be charged, and whether the resident is located away from the living environment 410.

By using just two data points, the system 400 can extrapolate valuable conclusions. Having additional data points would improve accuracy and understanding, providing even more valuable information to management and family members of residents from the living environment 410. As a result, the wellness, security, and monitoring of these residents can be improved.

As previously explained in reference to the Figures, the systems and methods disclosed in this application benefit senior populations. These systems and methods also benefit the families of senior individuals. Whether the system is used in an individual home or a shared community, the ease of use and autonomous pairing of sensing devices to a common network eliminate many barriers that have prevented segments of the population from realizing the benefits available with the IoT.

The above description references specific embodiments. However, various modifications, replacement with equivalents, and other changes may be made without departing from the broader spirit and scope of this application. The above description and figures are therefore to be regarded in an illustrative sense rather than a restrictive sense.

1. A system to monitor a living community, comprising:
a first broadband router having:
a first Internet-of-things (IoT) gateway to enable a first plurality of sensors to be paired to the first broadband router; and
a first receiver to receive sensor data from the first plurality of sensors;
a second broadband router having:
a second IoT gateway to enable a second plurality of sensors to be paired to the second broadband router; and
a second receiver to receive sensor data from the second plurality of sensors; and
a management platform configured to:
collect the sensor data from the first and second broadband routers;
arrange the sensor data;
grant selective access to the sensor data collected from the first and second broadband routers; and
send the sensor data to an access device for display.

2. The system of claim 1, wherein the management platform is further configured to receive, from the access device, input data corresponding to a profile and arrange the received input data according to the profile.

3. The system of claim 2, wherein the input data corresponding to the profile comprises daily intake of medicine.

4. The system of claim 1, wherein the first broadband router corresponds to a first profile and the second broadband router corresponds to a second profile, and wherein the management platform is further configured to arrange the collected sensor data on both a profile-by-profile basis and an aggregate basis.

5. The system of claim 4, wherein the management platform is further configured to arrange the collected sensor data to display graphs comparing the first profile with the second profile.

6. The system of claim 1, wherein the management platform is further configured to send a daily goal to the access device, wherein the daily goal is associated with a user profile.

7. The system of claim 1, wherein the management platform is further configured to send a first personalized daily goal to the first broadband router and a second personalized goal to the second broadband router, wherein the first and second personal goals are extrapolated from the collected sensor data.

8. The system of claim 1, wherein the first and second broadband routers are configured to autonomously pair a new sensor added to the system.

9. The system of claim 1, wherein the first and second broadband routers are configured to be pre-paired to a new sensor added to the system.

10. The system of claim 1, wherein the management platform is further configured to extrapolate a conclusion based on the sensor data collected from both the first and second broadband routers.

11. The system of claim 1, wherein the first and second broadband routers are configured to connect to a service-provider network during normal operation and to switch to a living community network when the service-provider network is unavailable.

12. A system to monitor a living community, comprising:
a first controller having:
a first gateway to enable a first sensor to be paired to the first controller; and
a first receiver to receive sensor data from the first sensor;
a second controller having:
a second gateway to enable a second sensor to be paired to the second controller; and
a second receiver to receive sensor data from the second sensor; and
a management platform configured to:
collect the sensor data from the first and second controllers;
arrange the sensor data collected from the first and second controllers;
grant selective access to the sensor data collected from the first and second controllers; and
send at least a portion of the sensor data collected from the first and second controllers to an access device for display.

13. The system of claim 12, wherein the management platform is further configured to receive, from the access device, input data corresponding to a profile and arrange the received input data according to the profile.

14. The system of claim 13, wherein the input data corresponding to the profile comprises daily intake of medicine.

15. The system of claim 12, wherein the first controller corresponds to a first profile and the second controller corresponds to a second profile and wherein the management platform is further configured to arrange the collected data on both a profile-by-profile basis and an aggregate basis.

16. The system of claim 15, wherein the management platform is further configured to arrange the sensor data to display graphs comparing the first profile with the second profile.

17. The system of claim 12, wherein the management platform is further configured to send a daily goal to the access device, wherein the daily goal is associated with a user profile.

18. The system of claim 12, wherein the management platform is further configured to send a first personalized daily goal to the first controller and a second personalized goal to the second controller, wherein the first and second personal goals are extrapolated from the collected sensor data.

19. The system of claim 12, wherein the first and second controllers are configured to autonomously pair a new sensor added to the system.

20. The system of claim 12, wherein the first and second controllers are configured to be pre-paired to a new sensor added to the system.

21. The system of claim 12, wherein the management platform is further configured to extrapolate a conclusion based on the sensor data collected from both the first and second controllers.

22. The system of claim 12, wherein the first and second controllers are configured to connect to a service-provider network during normal operation and to switch to a living community network when the service-provider network is unavailable.

23. A method to monitor a living community, comprising:
collecting sensor data from a first wireless router, wherein the first wireless router is configured to receive sensor data from a first plurality of sensors;
collecting sensor data from a second wireless router, wherein the second wireless router is configured to receive sensor data from a second plurality of sensors;
arranging the collected sensor data from the first and second wireless routers according to profile, wherein the first wireless router is associated with a first profile and the second wireless router is associated with a second profile; and
sending a portion of the collected sensor data to a management device to display the portion of the collected sensor data on both a profile-by-profile basis and an aggregate basis.

24. The method of claim 23, further comprising:
granting selective access to the collected sensor data on a profile-by-profile basis.

25. The method of claim 23, further comprising:
comparing sensor data collected from the first broadband wireless router with the sensor data collected from the second broadband wireless router.

26. The method of claim 23, further comprising:
sending a first personalized daily goal to the first broadband wireless router and a second personalized goal to the second broadband wireless router, wherein the first and second personalized goals are extrapolated from the collected sensor data.

27. The method of claim 23, further comprising:
pre-pairing a new sensor to either the first wireless router or the second wireless router.

28. The method of claim 23, further comprising;
extrapolating a conclusion based on sensor data collected from both the first and second wireless routers.
